(19) United States
(12) Patent Application Publication
(10) Pub. No.: US 2025/0229424 A1
(43) Pub. Date: Jul. 17, 2025

(54) System and Method for Estimating Properties of an Object

(71) Applicant: The Hong Kong University of Science and Technology, Hong Kong (CN)

(72) Inventors: Yajing SHEN, Hong Kong (CN); Xiong YANG, Hong Kong (CN); Zhengrong LING, Hong Kong (CN)

(21) Appl. No.: 19/011,644

(22) Filed: Jan. 7, 2025

Related U.S. Application Data
(60) Provisional application No. 63/620,146, filed on Jan. 11, 2024.

(51) Int. Cl. B25J 9/16; B25J 13/08; B25J 15/08; B25J 19/04

(52) U.S. Cl. CPC B25J 9/1679; B25J 13/084; B25J 15/08; B25J 19/04

(57) ABSTRACT

The present invention provides a system and a method for estimating object properties. The system comprises a multi-finger end effector equipped with tactile sensors capable of detecting normal and tangential forces at multiple contact points and enabling 3D interactive actions to gather comprehensive tactile information; an information processing unit including an action selector for dynamically generating action sequences based on prior knowledge of the object and desired properties and a property estimator for analysing collected tactile data to estimate object properties; and a data management unit for providing prior data for action selection and property estimation and saving new results and inputted parameters. By leveraging multi-point, multi-directional sensing, variable 3D testing actions, and multiple data-based estimation, this invention enhances the scope of object property estimation, addressing limitations of conventional tactile sensing approaches.

### CROSS-REFERENCE TO RELATED APPLICATIONS

The present application claims priority from the U.S. Provisional Patent Application No. 63/620,146 filed 11 Jan. 2024, and the disclosure of which is incorporated herein by reference in its entirety.

### FIELD OF THE INVENTION

The present invention generally relates to automatic object property estimation. More specifically the present invention relates to automatic object property estimation and manipulation based on multiple tangential tactile sensing.

### BACKGROUND OF THE INVENTION

Understanding the properties of objects is the basis of quality inspection, manipulation, and other further operations. In addition to vision, applying tactile sensing to estimate the comprehensive properties of objects is a common strategy for humans, while it is still a challenge for robots. To date, various types of tactile sensors have been proposed utilizing different transduction principles such as capacitance, piezo resistance, optics, magnetics, and barometric pressure. They have demonstrated high-resolution and self-decoupling abilities, allowing for the detection of both shear force and normal force, making them valuable tools for a range of applications, such as estimating grasp state, object shapes, and materials. For example, fabric touch testers have been developed to utilize tactile sensing system to recognize the texture, material, and heat-transfer characteristics of fabrics. The main interaction for sensor collection is through the pressing of the top plate probe. During each cycle of the probe's pressing on the fabric, the device can calculate the characteristics of the fabric, such as its thickness, shearing and bending properties, and compressibility, based on sensor data. However, one limitation of the fabric touch tester is that it utilizes only one fixed mode to contact the specimen, thereby restricting its ability to analyze a limited number of properties. Additionally, the fabric touch tester only utilizes a single-contact effector, which limits its ability to analyze the comprehensive properties of objects. Some tactile sensing systems may include an object test system, a tactile data processor, and a data storage system. By utilizing previous experience and test results, the system can select the optimal interactive action and analyze the properties of fabric based on the tactile data. However, most conventional tactile sensing devices is solely based on the value of the tactile sensors, ignore the significance of multi-point and multi-directional contact actions and 3D postures of the sensors. These devices have restricted ability to collect tangential tactile information by utilizing tangential interactive actions, thereby limiting the scope of state estimation and property analysis.

Some active perception approaches have been proposed to enhance the scope of property estimation by having variable contact positions and different end effector actions. However, the actions of the end effector are still constrained by a single contact point, failing to apply tangential interactive actions, such as pulling, and twisting, to fully use the tangential sensing capabilities of the tactile sensor. Therefore, there is still unmet needs for a solution to obtain comprehensive object property, especially the tangential property, to have better property estimation.

### SUMMARY OF THE INVENTION

It is an objective of the present invention to provide an automatic object property estimation system and method based on multiple tangential tactile sensing, especially the tangential property, to have better property estimation.

In accordance with a first aspect of the present invention, a system for estimating properties of an object is provided. The system comprises: a multi-finger end effector configured for performing one or more action sequences in a three-dimensional space to interact with multiple target contact points on the object and sensing tactile signals from the multiple target contact points; an information processing unit including: an action selector configured for selecting the one or more action sequences to be performed by the multi-finger end effector on basis of prior information of the object and one or more properties to be estimated; and generating action command to the multi-finger end effector; and a property estimator configured for estimating the one or more properties of the object on basis of the tactile signals sensed by the multi-finger end effector and the one or more action sequences performed by the multi-finger end effector; and a data management unit configured for storing a pool of action sequences available to be selected by the action selector, the prior information of the object, the one or more properties to be estimated, the one or more action sequence performed by the multi-finger end effector and the one or more properties of the object estimated by the property estimator. The tactile signals sensed from each contact point include signals indicative of a normal component and one or more tangential components of a contact force applied by the tactile sensor on the contact point.

In accordance with a second aspect of the present invention, a method for estimating properties of an object is provided. The method comprises: a) selecting, by an action selector, one or more action sequences to be performed by a multi-finger end effector in a three-dimensional space on basis of prior information of the object and one or more properties to be estimated; b) generating, by the action selector, action command to the multi-finger end effector; c) performing, by multiple tactile actuators of the multi-finger end effector, the selected action sequences to interact with multiple target contact points on the object; d) sensing, by multiple tactile sensors of the multi-finger end effector, tactile signals from the multiple target contact points; e) estimating, by a property estimator, the one or more properties of the object on basis of the tactile signals sensed by the multi-finger end effector and the one or more action sequence performed by the multi-finger end effector; f) evaluating, by the action selector, uncertainty levels of the one or more properties of the object estimated by the property estimator; g) comparing, by the action selector, the uncertainty levels against a threshold value; and h) if the uncertainty levels are greater than the threshold value, selecting, by the action selector, one or more supplementary action sequences to be performed by the multi-finger end effector for obtaining supplementary tactile signals from the multiple target contact points and repeating steps b) to g); and i) if the uncertainty levels are less than or equal to the threshold value; outputting the one or more properties of the object estimated by the property estimator as one or more estimation outputs.

By using multiple fingers equipped with advanced tactile sensors capable of normal forces and tangential forces sensing, as well as actuators capable of independently interacting with objects, enabling multiple interactive actions such as twisting and stretching, the provided system can run continuously and autonomously gathering a richer set of tactile information for object property estimation. Moreover, the present invention has provided a framework for analyzing both the tangential and normal properties of objects. Rather than the end effector for one contact point, it uses multi-finger to perform multi-point contacts enabling tangential interactive actions. To plan actions in both tangential and normal directions, an action selector is capable of generating the action sequence with variable tangential and normal forces during the process. The property estimator was also upgraded to fuse the action sequence, tactile data, and other information.

### BRIEF DESCRIPTION OF THE DRAWINGS

Embodiments of the invention are described in more details hereinafter with reference to the drawings, in which:

FIG. 1 illustrates a system for estimating properties of an object in accordance with one embodiment of the present invention;

FIG. 2 illustrates an example of multi-finger end effector in accordance with one embodiment of the present invention;

FIGS. 3A and 3B illustrate two examples of interactive actions performed by the multi-finger end effector of FIG. 2, respectively;

FIG. 4 illustrates an example form of a property estimator in accordance with one embodiment of the present invention; and

FIG. 5 illustrates a flowchart for a method for estimating properties of an object in accordance with one embodiment of the present invention.

### DETAILED DESCRIPTION

In the following description, details of the present invention are set forth as preferred embodiments. It will be apparent to those skilled in the art that modifications, including additions and/or substitutions may be made without departing from the scope and spirit of the invention. Specific details may be omitted so as not to obscure the invention; however, the disclosure is written to enable one skilled in the art to practice the teachings herein without undue experimentation.

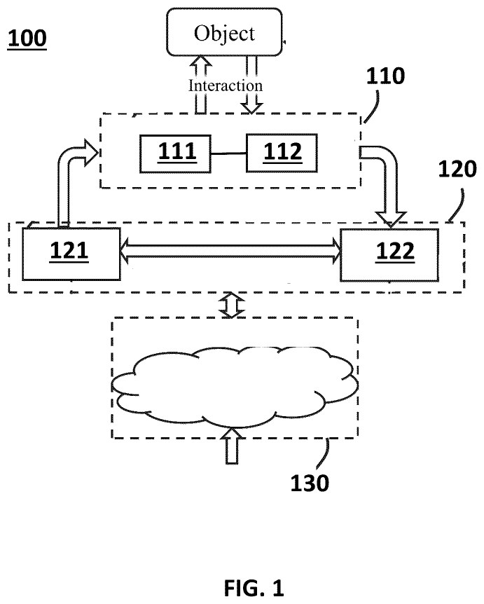

In accordance with a first aspect of the present invention, a system 100 for estimating properties of an object is provided. Referring to FIG. 1, in accordance with one embodiment of the present invention, the system 100 comprises a multi-finger end effector 110, an information processing unit 120; and a data management unit 130.

The multi-finger end effector 110 is configured for performing one or more action sequences in a three-dimensional space to interact with multiple target contact points on the object and sensing tactile signals from the multiple target contact points.

The multi-finger end effector 110 includes multiple tactile sensors 111 configured to interact with the multiple target contact points on the object to sense the tactile signals; and multiple tactile actuators 112 configured to perform the selected action sequences to facilitate the multiple tactile sensors to interact with the multiple target contact points.

The information processing unit 120 includes an action selector 121 configured for selecting the one or more action sequences to be performed by the multi-finger end effector 110 on basis of prior information of the object and one or more properties to be estimated; and generating action command to the multi-finger end effector 110.

The information processing unit 120 further includes a property estimator 122 configured for estimating the one or more properties of the object on basis of the tactile signals sensed by the multi-finger end effector 110 and the one or more action sequences performed by the multi-finger end effector 110.

The action selector 121 and the property estimator 122 may use various neural-networks with weights to perform the action selection and property estimation respectively. These neural-networks may be trained with some training sample data and stored in the data management unit.

In some embodiments, the multi-finger end effector 110 further includes multiple posture sensors configured for sensing postures of the multiple tactile sensors respectively; and the property estimator 122 is further configured to estimate the one or more properties of the object on basis of the tactile signals sensed by the multi-finger end effector, the action sequence performed by the multi-finger end effector and the postures of the multiple tactile sensors.

In some embodiments, the system further includes one or more thermal sensors for collecting thermal information of the object; and the property estimator 122 is further configured to estimate the one or more properties of the object on basis of the tactile signals sensed by the multi-finger end effector, the action sequence performed by the multi-finger end effector, the postures of the multiple tactile sensors and the collected thermal information.

The data management unit 130 stores the information supporting action selection and property estimation This information may be the expert rules, models, or weights of neural networks, or prior information of the object to be estimated. The information is sent to action selector 121 and property estimator 122 for action selection and property estimation. This information can be generated by the system or be input from an external source.

The data management unit may also store a pool of action sequences available to be selected by the action selector. The pool of action sequences may include, but not limited to, stroking action sequence, grasping action sequence, twisting action sequence, sloshing action sequence, pinching action sequence, stretching action sequence, pressing action sequence and any other interactive actions. These action sequences may be predefined and stored in the database, or designed by the action selector 121. The variety of the actions may increase due to the expansion of the database. Each action in the sequence may have variable direction and forces. For example, in the stroking action sequence, the stroking direction and the forces may be different at each time. During pinching an object, the direction and forces of each finger may change each time to drive the object to change its posture.

The properties to be estimated may include material properties, mechanical properties, physical properties, thermal properties, and other properties the user concerns. These properties may be numerical or categorical. These properties may be different according to different tasks and configured by the data from the data management unit.

In some embodiments, the system may further include a user interface allowing a user to input prior information of the object, such as a classification and geometry of the object, and the one or more properties to be estimated. The data management unit is further configured to store the prior information of the object and the one or more properties to be estimated.

For example, when the system is deployed as a fabric analysis device, the required prior information may include the position and size of the fabric, which may be input by the user through the user interface. A series of action sequences including press, stroke, and pull with different magnitude forces in different directions will be selected for this specific fabric analysis.

In some embodiments, the system may further include an image capturing device configured for capturing an image of the object. The information processing unit further includes an object classifier (not shown) configured for identifying the classification and a geometry of the object on basis of the captured image and determining the one or more properties to be estimated. The data management unit is further configured to store the identified geometry and classification of the object and the determined one or more properties to be estimated.

For example, when the system is deployed as a fruit ripeness detection device, the required prior information may include the class and basic shape of the fruit, which may be captured by the image capturing device cameras with fruit classification capabilities. A series of continuous pinching and weighing sequences in different directions will then be selected for this application.

In some embodiments, the action selector 121 may be further configured to retrieve the prior information of the object and the one or more properties to be estimated from the data management unit; select one or more initial action sequences to be performed by the multi-finger end effector 110 on basis of the prior information of the object and the one or more properties to be estimated; evaluate uncertainty levels of the one or more properties of the object estimated by the property estimator 122; comparing, by the action selector, the uncertainty levels against a threshold value; and select one or more supplementary action sequences to be performed by the multi-finger end effector 110 for obtaining supplementary tactile signals from the multiple target contact points to minimize the uncertainty levels. The uncertainty levels may be variances of the one or more properties of the object estimated by the property estimator 122.

The data management unit provides neural-networks with weights for the property estimator 122. The networks map the tactile and action data to the estimated friction, thickness, and elasticity. Then, the variance of the network is sent to the action selector 121 from the data management unit for evaluation. The result may be some area of the fabric is unknown, and the value of the thickness is unreliable. Therefore, according to the rules obtained from the Data Management Unit, the action selector 121 generates the next action sequence including the stroke the unknown area and measuring the thickness several times.

The tactile signals sensed from each contact point may include signals indicative of components of a contact force applied by the tactile sensor on the contact point; and the components of the contact force include a first component along a normal direction, a second component along a first tangential direction, and a third component along to second tangential direction orthogonal to the first tangential direction.

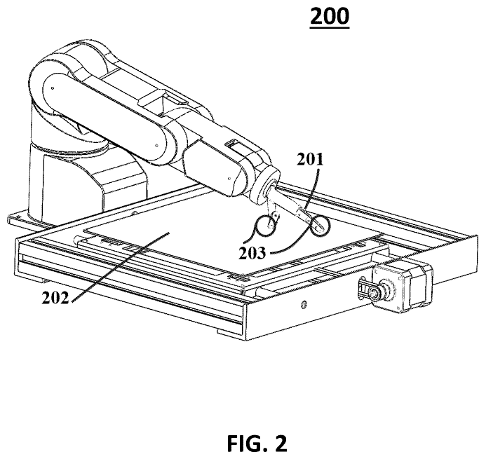

FIG. 2 illustrates an example of multi-finger end effector 200 in accordance with one embodiment of the present invention. The multi-finger end effector 200 can contact an object from tangential and normal directions at multiple points. The multi-finger end effector may include a platform 202 for fixing the object to be analyzed and a two-finger gripper 201 equipped with two self-decoupling tactile sensors 203. The two-finger gripper 201 can not only change the posture of the whole effector but also independently control the posture of each finger, to be able to contact the object in multiple points and directions.

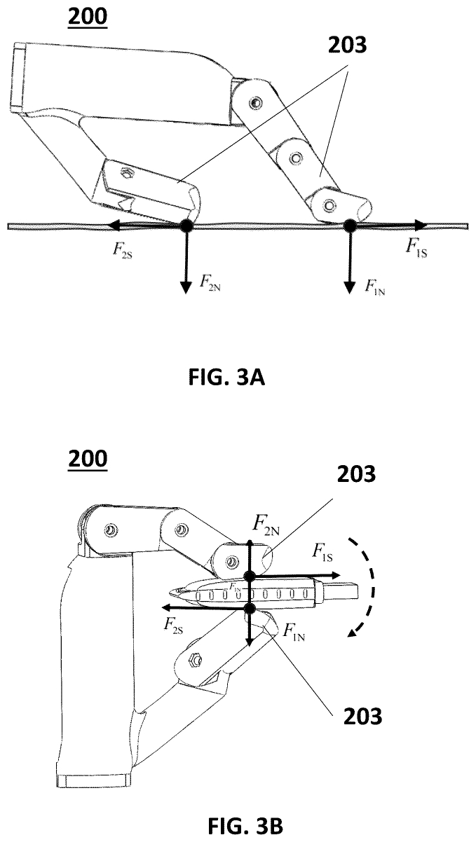

FIGS. 3A and 3B illustrate two examples of interactive actions performed by the multi-finger end effector 200 of FIG. 2. Referring to FIGS. 3A and 3B, with the help of two fingers 203, the end effector 200 can contact the object at different positions and apply forces in different directions. The interaction between the end effector 200 and the object is not limited to a plane, it can also be performed in 3D space.

FIG. 3A shows the end effector 200 stretching a hanging flat object. The forces F_{1N} and F_{2N} are both directed downwards and are used to hold the object. The forces F_{1S} and F_{2S} are directed in opposite directions and can cause the object to stretch horizontally. Given the elongation of the object Δs measured by the position sensor in the fingertips, the elastic coefficient k indicating the elasticity can be calculated by the tangential force as follows:

F_{1S}=F_{2S}=kΔs

FIG. 3B shows the end effector 200 rotating (pinching) an object. The forces FIN and F_{2N} are used to grip the object. The forces F_{1S} and F_{2S} are tangential and directed in opposite directions, causing the object to rotate. The direction and forces of each finger 203 change each time to drive the object to change its posture. Additionally, at a balanced state, the gravity magnitude and position of the gravity center can be calculated based on the balance of 3D forces and torques as follows:

$$\{ \begin{matrix}{\sum }_{i = 1}^{N} {\vec{r}}_{i} \times \vec{{F}_{ι}} + \vec{{r}_{g}} \vec{G} = \vec{0} \\ {\sum }_{i = 1}^{N} \vec{{F}_{ι}} + \vec{G} = \vec{0}\end{matrix}$$

which is with respect to a fixed world frame. The \vec{F}_{ι} and \hat{r}ᵢ are the 3D forces applied on the object and coordinates of the point of application. The \vec{G} and \vec{r_{g}} are the gravity and the position of the gravity center respectively.

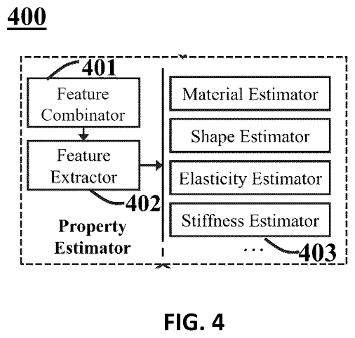

FIG. 4 illustrates an example form of a property estimator 400 in accordance with one embodiment of the present invention. The property estimator 400 may include a data combinator 401 configured to align and merge one or more types of data, such as tactile data and sensor posture data collected by the multi-finger end effector, and thermal data collected by the thermal sensors. The property estimator 400 may further include a feature extractor 402 configured to extract features from the merged data. The feature extraction performed by the feature extractor 402 may involve using a trained neural network. The property estimator 400 may further include multiple estimators 403, such as material estimator, shape estimator, elasticity estimator, and stiffness estimator, configured to receive the extracted data and do different kinds of properties estimation.

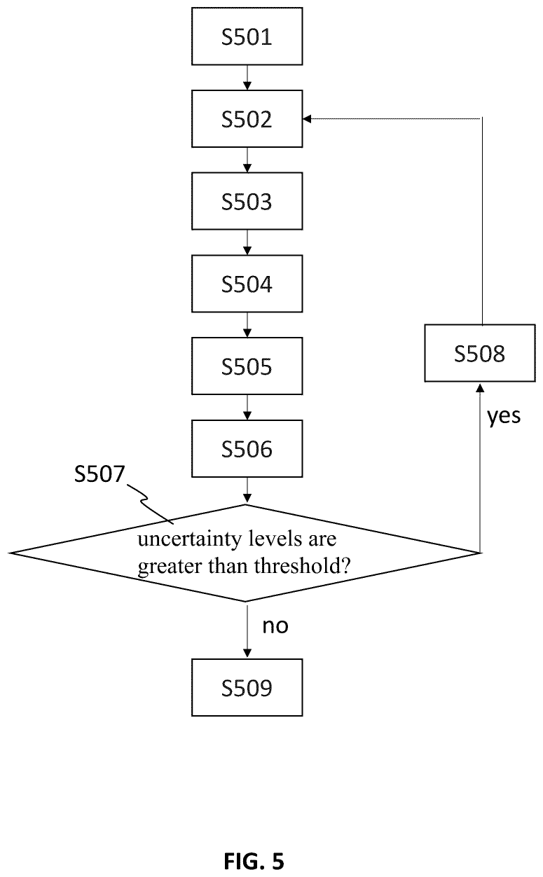

In accordance with a second aspect of the present invention, a method for estimating properties of an object is provided. Referring to FIG. 5, in accordance with one embodiment of the present invention, the method comprises the following steps:
S501: selecting, by an action selector, one or more action sequences to be performed by a multi-finger end effector in a three-dimensional space on basis of prior information of the object and one or more properties to be estimated;
S502: generating, by the action selector, action command to the multi-finger end effector;
S503: performing, by multiple tactile actuators of the multi-finger end effector, the selected action sequences to interact with multiple target contact points on the object;
S504: sensing, by multiple tactile sensors of the multi-finger end effector, tactile signals from the multiple target contact points; and
S505: estimating, by a property estimator, the one or more properties of the object on basis of the tactile signals sensed by the multi-finger end effector and the one or more action sequence performed by the multi-finger end effector.

In some embodiments, the method may further include:
S506: evaluating, by the action selector, uncertainty levels of the one or more properties of the object estimated by the property estimator;
S507: comparing, by the action selector, the uncertainty levels against a threshold value;
S508: if the uncertainty levels are greater than the threshold value, selecting, by the action selector, one or more supplementary action sequences to be performed by the multi-finger end effector for obtaining supplementary tactile signals from the multiple target contact points; and repeating steps S502 to S507; and
S509: if the uncertainty levels are less than or equal to the threshold value, outputting the one or more properties of the object estimated by the property estimator as one or more estimation outputs.

In some embodiments, the method may further comprise: capturing, by an image capturing device, an image of the object; and identifying, by an object classifier, a classification and a geometry of the object on basis of the captured image; and determining, by the object classifier, one or more properties to be estimated.

In some embodiments, the method may further comprise: sensing, by the multiple posture sensors, postures of the multiple tactile sensors respectively; and estimating, by the property estimator, the one or more properties of the object on basis of the tactile signals sensed by the multi-finger end effector, the action sequence performed by the multi-finger end effector and the postures of the multiple tactile sensors.

In some embodiments, the method may further comprise: collecting, by one or more thermal sensors, thermal information of the object; and estimating, by the property estimator, the one or more properties of the object on basis of the tactile signals sensed by the multi-finger end effector, the action sequence performed by the multi-finger end effector, the postures of the multiple tactile sensors and the collected thermal information.

The functional units and modules in accordance with the embodiments disclosed herein may be implemented using computing devices, computer processors, or electronic circuitries including but not limited to application specific integrated circuits (ASIC), field programmable gate arrays (FPGA), microcontrollers, and other programmable logic devices configured or programmed according to the teachings of the present disclosure. Computer instructions or software codes running in the computing devices, computer processors, or programmable logic devices can readily be prepared by practitioners skilled in the software or electronic art based on the teachings of the present disclosure.

All or portions of the methods in accordance to the embodiments may be executed in one or more computing devices including server computers, personal computers, laptop computers, mobile computing devices such as smartphones and tablet computers.

The embodiments may include computer storage media, transient and non-transient memory devices having computer instructions or software codes stored therein, which can be used to program or configure the computing devices, computer processors, or electronic circuitries to perform any of the processes of the present invention. The storage media, transient and non-transient memory devices can include, but are not limited to, floppy disks, optical discs, Blu-ray Disc, DVD, CD-ROMs, and magneto-optical disks, ROMs, RAMs, flash memory devices, or any type of media or devices suitable for storing instructions, codes, and/or data.

Each of the functional units and modules in accordance with various embodiments also may be implemented in distributed computing environments and/or Cloud computing environments, wherein the whole or portions of machine instructions are executed in distributed fashion by one or more processing devices interconnected by a communication network, such as an intranet, Wide Area Network (WAN), Local Area Network (LAN), the Internet, and other forms of data transmission medium.

While the present disclosure has been described and illustrated with reference to specific embodiments thereof, these descriptions and illustrations are not limiting. The illustrations may not necessarily be drawn to scale. There may be distinctions between the artistic renditions in the present disclosure and the actual apparatus due to manufacturing processes and tolerances. There may be other embodiments of the present disclosure which are not specifically illustrated. Modifications may be made to adapt a particular situation, material, composition of matter, method, or process to the objective and scope of the present disclosure. All such modifications are intended to be within the scope of the claims appended hereto. While the methods disclosed herein have been described with reference to particular operations performed in a particular order, it will be understood that these operations may be combined, sub-divided, or re-ordered to form an equivalent method without departing from the teachings of the present disclosure. Accordingly, unless specifically indicated herein, the order and grouping of the operations are not limitations.

What is claimed is:

1. A system for estimating properties of an object, comprising:
a multi-finger end effector configured for performing one or more action sequences in a three-dimensional space to interact with multiple target contact points on the object and sensing tactile signals from the multiple target contact points;
an information processing unit including:
an action selector configured for selecting the one or more action sequences to be performed by the multi-finger end effector on basis of prior information of the object and one or more properties to be estimated; and generating action command to the multi-finger end effector; and
a property estimator configured for estimating the one or more properties of the object on basis of the tactile signals sensed by the multi-finger end effector and the one or more action sequences performed by the multi-finger end effector; and
a data management unit configured for storing a pool of action sequences available to be selected by the action selector, the prior information of the object, the one or more properties to be estimated, the one or more action sequence performed by the multi-finger end effector and the one or more properties of the object estimated by the property estimator;
wherein the tactile signals sensed from each contact point include signals indicative of a normal component and one or more tangential components of a contact force applied by the tactile sensor on the contact point.

2. The system according to claim 1, wherein one or more tangential components include a first tangential component, and a second tangential component orthogonal to the first tangential component.

3. The system according to claim 1, further comprising a user interface allowing a user to input the prior information of the object and the one or more properties to be estimated; and
wherein the data management unit is further configured to store the input prior information of the object and the one or more properties to be estimated.

4. The system according to claim 1, further comprising an image capturing device configured for capturing an image of the object; and wherein
the information processing unit further includes an object classifier configured for identifying the classification and a geometry of the object on basis of the captured image and determining the one or more properties to be estimated; and
the data management unit is further configured to store the identified geometry and classification of the object and the determined one or more properties to be estimated.

5. The system according to claim 1, wherein the action selector is further configured for:
retrieving the prior information of the object and the one or more properties to be estimated from the data management unit;
selecting one or more initial action sequences to be performed by the multi-finger end effector on basis of the prior information of the object and the one or more properties to be estimated;
evaluating uncertainty levels of the one or more properties of the object estimated by the property estimator;
comparing, by the action selector, the uncertainty levels against a threshold value; and
selecting one or more supplementary action sequences to be performed by the multi-finger end effector for obtaining supplementary tactile signals from the multiple target contact points to minimize the uncertainty levels.

6. The system according to claim 5, wherein the uncertainty levels are variances of the one or more properties of the object estimated by the property estimator.

7. The system according to claim 1, further comprising one or more thermal sensors for collecting thermal information of the object; and
wherein the property estimator is further configured to estimate the one or more properties of the object on basis of the tactile signals sensed by the multi-finger end effector, the action sequence performed by the multi-finger end effector, and the collected thermal information.

8. The system according to claim 1, wherein the multi-finger end effector includes:
multiple tactile sensors configured to interact with the multiple target contact points on the object to sense the tactile signals; and
multiple tactile actuators configured to perform the selected action sequences to facilitate the multiple tactile sensors to interact with the multiple target contact points.

9. The system according to claim 8, wherein the multi-finger end effector further includes multiple posture sensors configured for sensing postures of the multiple tactile sensors respectively; and
the property estimator is further configured to estimate the one or more properties of the object on basis of the tactile signals sensed by the multi-finger end effector, the action sequence performed by the multi-finger end effector and the postures of the multiple tactile sensors.

10. The system according to claim 9, further comprising one or more thermal sensors for collecting thermal information of the object; and
wherein the property estimator is further configured to estimate the one or more properties of the object on basis of the tactile signals sensed by the multi-finger end effector, the action sequence performed by the multi-finger end effector, the postures of the multiple tactile sensors and the collected thermal information.

11. A method for estimating properties of an object, comprising:
a) selecting, by an action selector, one or more action sequences to be performed by a multi-finger end effector in a three-dimensional space on basis of prior information of the object and one or more properties to be estimated;
b) generating, by the action selector, action command to the multi-finger end effector;
c) performing, by multiple tactile actuators of the multi-finger end effector, the selected action sequences to interact with multiple target contact points on the object;
d) sensing, by multiple tactile sensors of the multi-finger end effector, tactile signals from the multiple target contact points; and
e) estimating, by a property estimator, the one or more properties of the object on basis of the tactile signals sensed by the multi-finger end effector and the one or more action sequence performed by the multi-finger end effector;
wherein the tactile signals sensed from each contact point include signals indicative of a normal component and one or more tangential components of a contact force applied by the tactile sensor on the contact point.

12. The method according to claim 11, further comprising:
f) evaluating, by the action selector, uncertainty levels of the one or more properties of the object estimated by the property estimator; and
g) comparing, by the action selector, the uncertainty levels against a threshold value;
h) if the uncertainty levels are greater than the threshold value, selecting, by the action selector, one or more supplementary action sequences to be performed by the multi-finger end effector for obtaining supplementary tactile signals from the multiple target contact points and repeating steps b) to g); and
i) if the uncertainty levels are less than or equal to the threshold value; outputting the one or more properties of the object estimated by the property estimator as one or more estimation outputs.

13. The method according to claim 11, further comprising:
capturing, by an image capturing device, an image of the object; and
identifying, by an object classifier, a classification and a geometry of the object on basis of the captured image; and
determining, by the object classifier, one or more properties to be estimated.

14. The method according to claim 11, further comprising:
sensing, by the multiple posture sensors, postures of the multiple tactile sensors respectively; and
estimating, by the property estimator, the one or more properties of the object on basis of the tactile signals sensed by the multi-finger end effector, the action sequence performed by the multi-finger end effector and the postures of the multiple tactile sensors.

15. The method according to claim 14, further comprising:
collecting, by one or more thermal sensors, thermal information of the object; and
estimating, by the property estimator, the one or more properties of the object on basis of the tactile signals sensed by the multi-finger end effector, the action sequence performed by the multi-finger end effector, the postures of the multiple tactile sensors and the collected thermal information.
